(19) United States
(12) Patent Application Publication
(10) Pub. No.: US 2008/0294675 A1
(43) Pub. Date: Nov. 27, 2008

(54) Column file storage estimation tool with text indexes

(75) Inventor: Richard Lewis, Alexandria, VA (US)

Correspondence Address: BINGHAM MCCUTCHEN LLP, 2020 K Street, N.W., Intellectual Property Department, WASHINGTON, DC, 20006, US

(73) Assignee: ORACLE INTERNATIONAL CORPORATION

(21) Appl. No.: 11/802,676

(22) Filed: May 24, 2007

(51) Int. Cl. G06F 17/00

(52) U.S. Cl. 707/102; 707/E17.049

(57) ABSTRACT

A technique for estimating the amount of resources that will be needed in order to implement a database service is provided. A method of providing resources for a database service comprises generating an estimate of a size of an index for a data table based on statistics relating to the data table, providing resources based on the generated estimate, and generating the index for the data table and storing the index in the provided resources.

### BACKGROUND OF THE INVENTION

1. Field of the Invention

The present invention relates to estimating resource usage, such as disk space usage, by database structures, such as text indexes.

2. Description of the Related Art

In order to implement new database services, sufficient resources must be provided for those services. For example, in a database, in order to provide quick and efficient access to data stored in the database, indexes relating to the stored data are generated. Depending on the type of data, these indexes may be quite large and may require a large amount of storage space, such as hard disk space. For example, databases containing textual data, such as the contents of word processing documents, typically require large indexes in order to access the data. In order to properly implement such a database service, sufficient resources, such as hard disk space, must be provided to the database. Previously there was no single way to estimate the rough largest amount of disk space needed for indexes, such as text indexes, without creating smaller indexes and computing the size difference manually. Provision of too few resources, such as providing too little hard disk space, causes the implemented service to have poor performance, or even to not work at all. On the other hand, provision of too many resources, such as providing too much hard disk space, is expensive and wasteful of resources.

In these and many other situations, a need arises for a technique for estimating the amount of resources that will be needed in order to implement a database service.

### SUMMARY OF THE INVENTION

The present invention provides a technique for estimating the amount of resources that will be needed in order to implement a database service.

In one embodiment of the present invention, a method of providing resources for a database service comprises generating an estimate of a size of an index for a data table based on statistics relating to the data table, providing resources based on the generated estimate, and generating the index for the data table and storing the index in the provided resources. The resources may comprise storage. The storage may comprise at least a portion of at least one hard disk drive. Statistics may comprise at least one of an average length of entries in a column of the data table and a number of occupied rows in the column of the data table. Data in at least one column of the data table may comprise text.

### BRIEF DESCRIPTION OF THE DRAWINGS

Further features and advantages of the invention can be ascertained from the following detailed description that is provided in connection with the drawings described below:

FIG. 1 is an exemplary block diagram of a database management system in which the present invention may be implemented.

FIG. 2 is an exemplary flow diagram of a process of estimating resources needed to implement a database service.

### DETAILED DESCRIPTION OF THE PREFERRED EMBODIMENTS

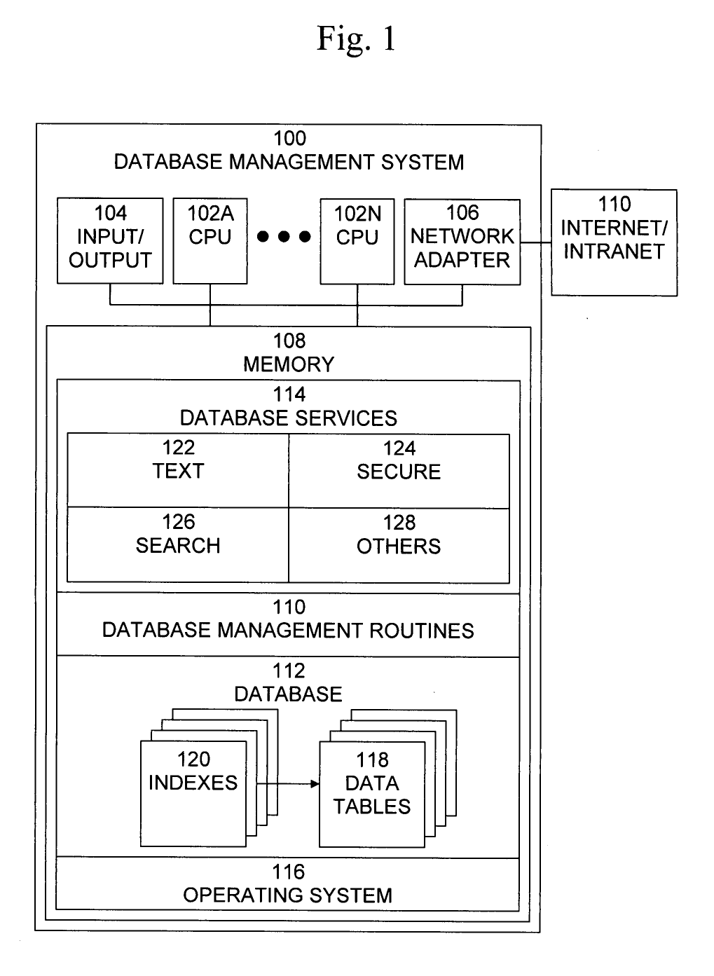

An exemplary block diagram of a database management DBMS 100 in which the present invention may be implemented, is shown in FIG. 1. DBMS 100 is typically a programmed general-purpose computer system, such as a personal computer, workstation, server system, and minicomputer or mainframe computer. DBMS 100 includes one or more processors (CPUs) 102A-102N, input/output circuitry 104, network adapter 106, and memory 108. CPUs 102A-102N execute program instructions in order to carry out the functions of the present invention. Typically, CPUs 102A-102N are one or more microprocessors, such as an INTEL PENTIUM® processor. FIG. 1 illustrates an embodiment in which DBMS 100 is implemented as a single multi-processor computer system, in which multiple processors 102A-102N share system resources, such as memory 108, input/output circuitry 104, and network adapter 106. However, the present invention also contemplates embodiments in which DBMS 100 is implemented as a plurality of networked computer systems, which may be single-processor computer systems, multi-processor computer systems, or a mix thereof.

Input/output circuitry 104 provides the capability to input data to, or output data from, database/DBMS 100. For example, input/output circuitry may include input devices, such as keyboards, mice, touchpads, trackballs, scanners, etc., output devices, such as video adapters, monitors, printers, etc., and input/output devices, such as, modems, etc. Network adapter 106 interfaces database/DBMS 100 with Internet/intranet 110. Internet/intranet 110 may include one or more standard local area network (LAN) or wide area network (WAN), such as Ethernet, Token Ring, the Internet, or a private or proprietary LAN/WAN.

Memory 108 stores program instructions that are executed by, and data that are used and processed by, CPU 102 to perform the functions of DBMS 100. Memory 108 may include electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

The contents of memory 108 varies depending upon the functions that DBMS 100 is programmed to perform. One of skill in the art would recognize that these functions, along with the memory contents related to those functions, may be included on one system, or may be distributed among a plurality of systems, based on well-known engineering considerations. The present invention contemplates any and all such arrangements.

In the example shown in FIG. 1, memory 108 includes database management routines 110, database 112, database 114, database services 115, and operating system 116. Database management routines 110 provide the capability to store, access, and manage information in one or more databases, such as those included in database 112. Database 112 provides storage and organization for information from one or more data tables included in database 112. For example, database 112 may include data tables 118, which store data, and indexes 120, which provide the capability to quickly access particular data. Database services 114 include particular features that may be provided by the system. For example, database services 114 may include text services 122, secure services 124, search services 126, and other services 128. Operating system 116 provides overall system functionality.

From a technical standpoint, databases can differ widely. The terms relational, network, flat, and hierarchical all refer to the way a database organizes information internally. The internal organization can affect how quickly and flexibly you can extract information.

Each database includes a collection of information organized in such a way that computer software can select and retrieve desired pieces of data. Traditional databases are organized by fields, records, and files. A field is a single piece of information; a record is one complete set of fields; and a file is a collection of records. An alternative concept in database design is known as Hypertext. In a Hypertext database, any object, whether it be a piece of text, a picture, or a film, can be linked to any other object. Hypertext databases are particularly useful for organizing large amounts of disparate information, but they are not designed for numerical analysis.

Typically, a database includes not only data, but also low-level database management functions, which perform accesses to the database and store or retrieve data from the database. Such functions are often termed queries and are performed by using a database query language, such as Structured Query Language (SQL). SQL is a standardized query language for requesting information from a database. Historically, SQL has been a popular query language for database management systems running on minicomputers and mainframes. Increasingly, however, SQL is being supported by personal computer database systems because it supports distributed databases (databases that are spread out over several computer systems). This enables several users on a local-area network to access the same database simultaneously.

Most full-scale database systems are relational database systems. Small database systems, however, use other designs that provide less flexibility in posing queries. Relational databases are powerful because they require few assumptions about how data is related or how it will be extracted from the database. As a result, the same database can be viewed in many different ways. An important feature of relational systems is that a single database can be spread across several tables. This differs from flat-file databases, in which each database is self-contained in a single table.

Typically, a database application, includes data entry functions and data reporting functions. Data entry functions provide the capability to enter data into a database. Data entry may be performed manually, by data entry personnel, automatically, by data entry processing software that receives data from connected sources of data, or by a combination of manual and automated data entry techniques. Data reporting functions provide the capability to select and retrieve data from a database and to process and format that data for other uses. Typically, retrieved data is used to display information to a user, but retrieved data may also be used for other functions, such as account settlement, automated ordering, numerical machine control, etc.

Database applications typically make use of database services 114, which provide particular features to the system. For example, text services 122 may provide the capability to use standard SQL to index, search, and analyze text and documents stored in the database, in files, and on the web. The text services may perform linguistic analysis on documents, as well as search text using a variety of strategies including keyword searching, context queries, Boolean operations, pattern matching, mixed thematic queries, HTML/XML section searching, and so on. The text services may render search results in various formats including unformatted text, HTML with term highlighting, and original document format. The text services may support multiple languages and use relevance-ranking technology to improve search quality. The text services may also offer features like classification, clustering, and support for information visualization metaphors.

As another example, secure services 124 may provide the security capabilities in the areas of privacy, regulatory compliance, and data consolidation. Such features may include column based access controls with Virtual Private Database, enhancements to Fine Grained Auditing, support for the AES algorithm for database encryption, expanded support for PKI and integration of Label Security with Identity Management.

As another example, search service 126 may provide the capability to perform a secure, high quality, easy-to-use search across all enterprise information assets. The secure services may provide the capability to search and locate public, private and shared content across Intranet web-servers, databases, files on local disk or on file-servers, IMAP email, document management systems, applications, and portals. The secure services may provide highly secure crawling, indexing, and searching spanning diverse public or private data sources and analytics on search results and understanding of usage patterns.

Other database services 128 may also or alternatively be provided. The present invention is not limited to the particular exemplary services described above, but rather contemplates use with any database service that uses resources.

As shown in FIG. 1, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

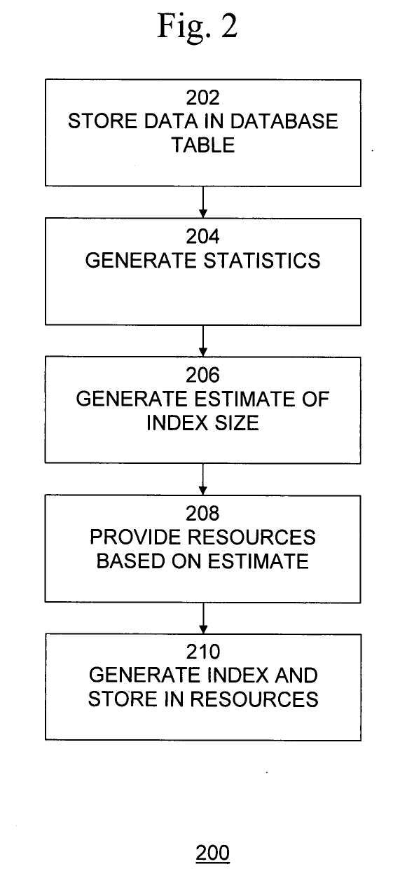

A process 200 of estimating resources needed to implement a database service is shown in FIG. 2. Process 200 begins with step 202, in which the data is stored in one or more tables in the database. In step 204, statistics relating to the stored data are generated. For example, for text data, a data table may have a text column with a capacity of 2000 characters and the table may have 1 billion rows. The generated statistics may indicate that only the column has an average of only 100 characters per entry and that only 50% of the rows have data. In step 206, an estimate of the size of the index needed to index the column of the data table is generated. For example, an estimate may be generated as follows:

select
tab.owner,
tab.table_name,
col.column_name,
col.data_type,
tab.num_rows*col.avg_col_len/1024/1024 Column_Size_in_MB,
tab.num_rows*col.avg_col_len/1024/1024* 15
CTXCAT_Index_Size_in_MB,
tab.num_rows*col.avg_col_len/1024/1024* 100
CONTEXT_Index_Size in_MB
from dba_tab_columns col, dba_tables tab
where tab.table_name=col.table_name
/

In this example, the average length of entries in the column (col.avg_col_len) and the number of rows in the table (or the number of occupied rows in the column) is used to generate an estimate of the column size, and estimate of the catalog index size, and an estimate of the context index size.

In step 208, resources, such as hard drive space, are provided based on the estimate generated in step 206. In step 210, the indexes are generated and stored in the resources provided in step 208.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROM's, as well as transmission-type media, such as digital and analog communications links.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method of providing resources for a database service comprising:
generating an estimate of a size of an index for a data table based on statistics relating to the data table;
providing resources based on the generated estimate; and
generating the index for the data table and storing the index in the provided resources.

2. The method of claim 1, wherein the resources comprise storage.

3. The method of claim 2, wherein the storage comprises at least a portion of at least one hard disk drive.

4. The method of claim 1, wherein statistics comprise at least one of an average length of entries in a column of the data table and a number of occupied rows in the column of the data table.

5. The method of claim 1, wherein data in at least one column of the data table comprises text.

6. A system for providing resources for a database service comprising:
a processor operable to execute computer program instructions;
a memory operable to store computer program instructions executable by the processor; and
computer program instructions stored in the memory and executable to perform the steps of:
generating an estimate of a size of an index for a data table based on statistics relating to the data table;
providing resources based on the generated estimate; and
generating the index for the data table and storing the index in the provided resources.

7. The system of claim 6, wherein the resources comprise storage.

8. The system of claim 7, wherein the storage comprises at least a portion of at least one hard disk drive.

9. The system of claim 6, wherein statistics comprise at least one of an average length of entries in a column of the data table and a number of occupied rows in the column of the data table.

10. The system of claim 6, wherein data in at least one column of the data table comprises text.

11. A computer program product for providing resources for a database service comprising:
a computer readable storage medium;
computer program instructions, recorded on the computer readable storage medium, executable by a processor, for performing the steps of
generating an estimate of a size of an index for a data table based on statistics relating to the data table;
providing resources based on the generated estimate; and
generating the index for the data table and storing the index in the provided resources.

12. The computer program product of claim 11, wherein the resources comprise storage.

13. The computer program product of claim 12, wherein the storage comprises at least a portion of at least one hard disk drive.

14. The computer program product of claim 11, wherein statistics comprise at least one of an average length of entries in a column of the data table and a number of occupied rows in the column of the data table.

15. The computer program product of claim 11, wherein data in at least one column of the data table comprises text.
